(19) United States
(12) Patent Application Publication
(10) Pub. No.: US 2016/0039365 A1
(43) Pub. Date: Feb. 11, 2016

(54) Systems and Methods for Sending A Message From Tire Pressure Monitoring System to Body Electronics

(71) Applicant: Johnson Controls Technology Company, Holland, MI (US)

(72) Inventor: Philip J. VANDERWALL, Marne, MI (US)

(73) Assignee: Johnson Controls Technology Company, Holland, MI (US)

(21) Appl. No.: 14/455,437

(22) Filed: Aug. 8, 2014

(51) Int. Cl. B60R 16/023; B60C 23/00

(52) U.S. Cl. CPC B60R 16/023; B60C 23/00

(57) ABSTRACT

A tire pressure monitoring system electronic control unit for hands free operation of a trunk of a vehicle includes a receiver configured to receive pressure data transmitted from a tire pressure monitoring system sensor, and also include a vehicle controller area network interface configured to send a control signal to a body control module using a vehicle network. The tire pressure monitoring system electronic control unit further includes a control circuit configured to send the control signal to the body control module using the vehicle controller area network interface, wherein the control signal causes the body control module to open the trunk of the vehicle, and wherein the control circuit sends the control signal in response to determining, using the pressure data, that the tire of the vehicle has been kicked.

### BACKGROUND

Vehicles include sensors dedicated to functions such as safe operation of the vehicle, monitoring vehicle status, controlling aspects of the vehicle, and/or otherwise providing data to vehicle systems. Vehicles further include storage areas, doors, windows, and/or other hardware which secures cargo and/or controls access to the interior of the vehicle. Vehicle accessories may be used to control access to a vehicle. For example, a key fob may transmit a signal to a vehicle which causes the vehicle to open a trunk in response. This may require a user to operate the key fob by pressing a button with his or her hands. It is challenging and difficult to develop a system which allows a user to access the interior of a vehicle. It is further challenging and difficult to develop a hands free system which allows a user to access the interior of a vehicle using sensors included in the vehicle.

### SUMMARY

One embodiment relates to a tire pressure monitoring system electronic control unit for hands free operation of a trunk of a vehicle. The tire pressure monitoring system electronic control unit includes a receiver configured to receive pressure data transmitted from a tire pressure monitoring system sensor, and also include a vehicle controller area network interface configured to send a control signal to a body control module using a vehicle network. The tire pressure monitoring system electronic control unit further includes a control circuit configured to send the control signal to the body control module using the vehicle controller area network interface, wherein the control signal causes the body control module to open the trunk of the vehicle, and wherein the control circuit sends the control signal in response to determining, using the pressure data, that the tire of the vehicle has been kicked.

Another embodiment relates to a method for operating a trunk of a vehicle based on a kick of a tire of the vehicle. The method includes receiving pressure data at a control circuit from, directly or indirectly, one or more tire pressure monitoring system sensors. The method further includes determining, using the control circuit, if the tire of the vehicle has been kicked based on the pressure data and sending a control signal, directly or indirectly, to an actuator. The actuator opens the trunk of the vehicle in response to receiving the control signal.

Another embodiment relates to an apparatus for a vehicle and for hands free operation of a portion of the vehicle. The apparatus includes a tire pressure sensor configured to measure the pressure within a tire of the vehicle, an actuator coupled to the portion of the vehicle and configured to cause the portion of the vehicle to open in response to a control signal, and a control circuit configured to receive pressure data from the tire pressure sensor and configured to send the control signal to the actuator. The control circuit can be configured to send the control signal in response to determining, based on the pressure data, that the tire has been kicked.

### BRIEF DESCRIPTION OF THE DRAWINGS

FIG. 1 is an illustration of a vehicle according to an exemplary embodiment.

FIG. 2A is a schematic illustration of a tire pressure monitoring system included in a vehicle according to an exemplary embodiment.

FIG. 2B is an illustration of a block diagram of the components of a tire pressure monitoring system sensor according to an exemplary embodiment.

FIG. 2C is an illustration of a block diagram of the components of a tire pressure monitoring system electronic control unit according to an exemplary embodiment.

FIG. 3A is a schematic illustration of a body control module and related hardware included in a vehicle according to an exemplary embodiment.

FIG. 3B is an illustration of a block diagram of the components of a body control module according to an exemplary embodiment.

FIG. 4A is a schematic illustration of a vehicle network including components for sensing a tire kick and opening a vehicle in response to the tire kick according to an exemplary embodiment.

FIG. 4B is an illustration of a block diagram of the components of a trunk electronics control unit for opening the trunk of a vehicle in response to tire kick according to an exemplary embodiment.

FIG. 5 is a schematic illustration of a vehicle with a remote keyless entry system according to an exemplary embodiment.

FIG. 6 is an illustration of a block diagram for a method of opening a vehicle trunk in response to a tire kick detected by a tire pressure monitoring system according to an exemplary embodiment.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Generally, a vehicle may include storage areas. For example, a car may include a trunk. A vehicle may also include one or more devices to control ingress to the vehicle, and/or egress from the vehicle. For example, a car may include doors and/or windows which may open and/or close. In some embodiments, these features may be locked and unlocked for further control.

The vehicle may include a body controller or body control module which controls the locking, unlocking, opening, and/or closing of doors, windows, a trunk, and/or other features of a vehicle.

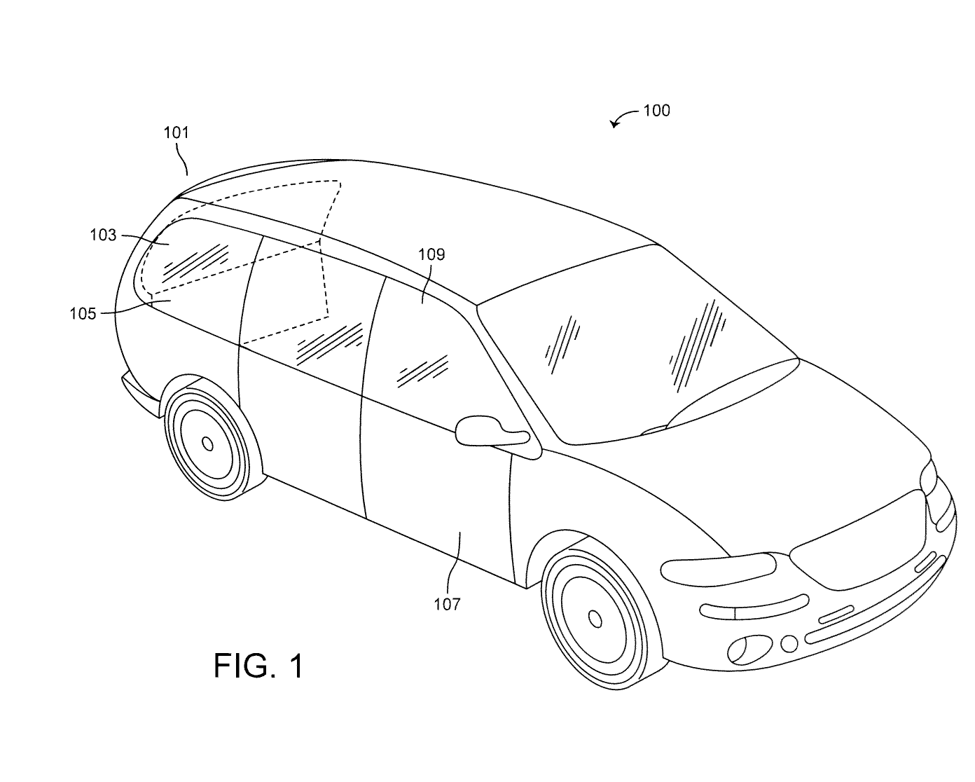

Referring to FIG. 1, vehicle 100 is illustrated according to one embodiment. Vehicle 100 may be a car, truck, sport utility vehicle, van, bus, or other vehicle for ground transportation. In some embodiments, vehicle 100 is a vehicle for air or water transportation. For example, vehicle 100 may be a plane, boat, or other aircraft or watercraft.

Vehicle 100 can include one or more doors 107. Vehicle 100 can also include one or more windows 109. In some embodiments, vehicle 100 controls the locking, unlocking, opening, and/or closing of doors 107 and/or windows 109. Vehicle 100 can control these functions using one or more body control modules and actuators. For example, vehicle 100 can receive a command from a remote using a remote keyless entry system. The remote keyless entry system can send a command to a body control module using a vehicle network which causes the body control module to lock, unlock, open, or close the window 109 or door 107.

In some embodiments, vehicle 100 includes a trunk 101. Trunk 101 can be any vehicle structure for containing cargo and/or passengers. For example, trunk 101 can include a trunk lid and a compartment separated from or partially separated from a passenger cabin of vehicle 100. Trunk 101 may be a trunk as typically found in sedan type vehicles. Trunk 101 can also be a trunk lid for a vehicle 100 which is a hatchback. Trunk 101 can include a glass rear window and open partially or entirely to a combined cargo and passenger cabin area. In alternative embodiments, trunk 101 includes an upper liftgate 103 and a lower liftgate 105. The upper liftgate 103 and lower liftgate 105 allow trunk 101 to be opened completely or partially. For example, lower liftgate 105 can be opened to open trunk 101 completely. Alternatively, upper liftgate 103 can be opened while lower liftgate 105 remains closed. In some embodiments, the upper liftgate 103 is made of or includes a glass rear window and the lower liftgate 105 is or includes a rear body panel. Trunk 101 can be locked, unlocked, opened, and/or closed by a body control module of vehicle 100. The body control module can actuate or control one or more actuators to perform the above described functions. The body control module can also be controlled by signals received from other electronics systems of vehicle 100 through a vehicle network.

Referring generally to the FIGURES, vehicle 100 can include a tire pressure monitoring system which is used to open trunk 101 in response to determining that a tire of vehicle 100 has been kicked. The system described herein allows for a user to kick a tire of vehicle 100 in order to cause trunk 101 to be opened (e.g., by a body control module and one or more actuators). Advantageously, this allows a user to open trunk 101 of vehicle 100 without using his or her hands. This provides an advantage in that a user may have his or her hands full (e.g., with cargo or passengers for transporting with vehicle 101) and cannot open trunk 101 by using a remote from a remote keyless entry system or manually actuating a handle included in trunk 101. Furthermore, the system described herein provides an advantage in that the system utilizes a tire pressure monitoring system which may be already existing in vehicle 100 (or a design for vehicle 100). For example, the tire pressure monitoring system may be used to alert a vehicle occupant to low tire pressure. The tire pressure monitoring system may be required by government regulations to be included in vehicle 100. Thus, a system using the tire pressure monitoring system to control access to vehicle 100 as described herein provides an advantage in that it utilizes existing systems. The system described herein provides for hands free operation of the trunk 101 and/or other components of vehicle 100 without requiring the instillation of a dedicated sensor in vehicle 100 (e.g., an infrared or other proximity or motion sensor for detecting a body part of a user). As described herein, the hands free system can be used to open trunk 101. Similar techniques and/or the same techniques disclosed herein with reference to trunk 101 can also be applied by the hands free system to other features of vehicle 100 in order to open or otherwise control one or more windows 109, doors 107, and/or other parts of vehicle 100 used for controlling ingress to the vehicle 100 and egress from the vehicle 100.

In one embodiment, a user's kick of a tire of vehicle 100 is detected using a pressure sensor of the tire pressure monitoring system. A control circuit can determine from a pressure change in the data provided by the sensor and/or tire pressure monitoring system that the tire of vehicle 100 has been kicked by a user. The control circuit can then send a signal using a network of the vehicle 100 which causes trunk 101 to be opened by an actuator. For example, the signal may be received by a body control module which in turn activates an actuator to open trunk 101. In further embodiments, the control circuit determines that one or more prior conditions have been met before sending the signal to open trunk 101. For example, the control circuit may determine that a key fob or other remote from a remote keyless entry system is within communications range with vehicle 100, that vehicle 100 is in park, the engine of vehicle 100 is not on, and/or that other prior conditions are met. Advantageously, the prior conditions may prevent unauthorized entry to vehicle 100 and/or inadvertent opening of trunk 101 or other portions of vehicle 100 (e.g., while vehicle 100 is moving).

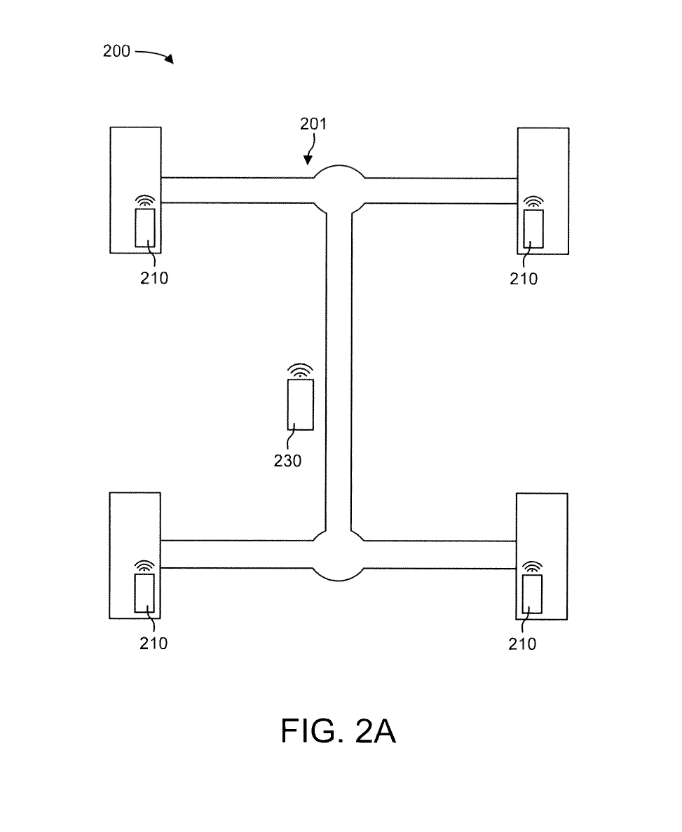

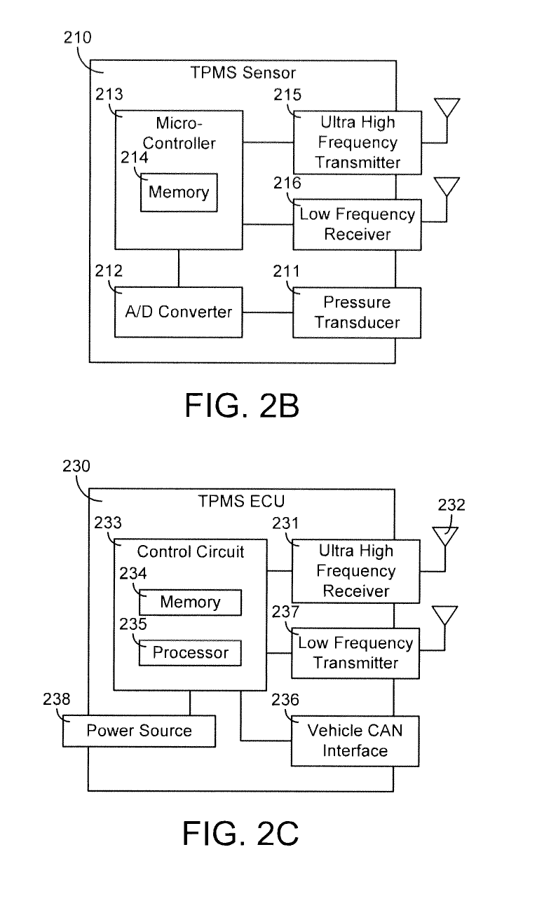

As described with reference to FIGS. 2C, 3B, and 4B, the control circuit is located in different components in various embodiments. For example, the control circuit may be a control circuit of a tire pressure monitoring system 230. The control circuit can perform the functions of the tire pressure monitoring system 230 (e.g., receiving pressure sensor data, calculating the pressure, sending alert signals to be displayed by an instrument cluster, etc.) in addition to performing the functions of the hands free trunk system described herein. In other words, a control circuit of an existing tire pressure monitoring system 230 (or designed tire pressure monitoring system 230) can be programmed to perform the additional functions described herein (e.g., sending a signal to a body control module 310, determining that prior conditions have been met, etc.).

In an alternative embodiment, the control circuit may be a control circuit of a body control module 310. The body control module 310 can receive tire pressure information from the tire pressure monitoring system 230 of vehicle 100 through a vehicle network. Using this information, the body control module 310 can determine if a tire has been kicked. The body control module 310 can also determine if prior conditions have been met. The body control module 310 can then actuate one or more actuators to open trunk 101. The control circuit can also perform the functions typical of a body control module 310 (e.g., receiving signals or information from a remote keyless entry system and/or controlling one or more actuators or other systems to unlock or lock a door 107 of vehicle 100, open a trunk 101 or otherwise control a component of vehicle 100).

In still further alternative embodiments, the control circuit is a general purpose control circuit or control circuit specific for hands free operation of trunk 101. The control circuit is not included in a tire pressure monitoring system 230 or body control module 310. The control circuit can communicate with the tire pressure monitoring system 230 and body control module 310 using a vehicle network. The control circuit can receive tire pressure data from the tire pressure monitoring system, determine if a tire has been kicked, determine if prior conditions have been met, and can send a signal to the body control module 310 causing the body control module 310 to open trunk 101. The control circuit may be included in a trunk electronic control unit 409.

Referring now to FIG. 2A, vehicle drivetrain 200 is illustrated according to one embodiment which includes tire pressure monitoring system 201. Tire pressure monitoring system 201 is a direct tire pressure monitoring system. Tire pressure monitoring system (TPMS) 201 can include TPMS sensors 210. TPMS sensors 210 can measure the tire pressure of each tire of vehicle 100. In some embodiments, tire pressure monitoring system 201 includes TPMS electronic control unit (ECU) 230. TPMS electronic control unit 230 can activate TPMS sensors 210, receive pressure data from TPMS sensors 210, and/or otherwise determine the pressure of one or more tires of vehicle 100.

In one embodiment, tire pressure monitoring system 201 includes one TPMS sensor 210 for each tire of vehicle 100. TPMS sensors 210 can be mounted on a wheel or rim of vehicle 100 or otherwise be located within the tire(s) of vehicle 100. Using wireless radio frequency communications, TPMS sensors 210 can communicate with TPMS electronic control unit 230. In alternative embodiments, other types of tire pressure monitoring systems are used.

Referring now to FIG. 2B, a TPMS sensor 210 is illustrated according to an exemplary embodiment. TPMS sensor 210 is used to measure the pressure within a tire of vehicle 100. The measured pressure can be communicated by TPMS sensors 210 and/or other components of tire pressure monitoring system 201 for use in the hands free trunk system described herein. In some embodiments, TPMS sensor 210 includes a pressure transducer 211. Pressure transducer 211 measures the pressure within a tire of vehicle 100. For example, pressure transducer 211 may contain piezoelectric materials for use in measuring the pressure within the tire. In other embodiments of TPMS sensor 210, various other pressure sensors are used in place of pressure transduced 211.

In some embodiments, TPMS sensors 210 includes an analog to digital converter 212. The analog to digital converter 212 converts an analog measurement of tire pressure from pressure transducer 211 into a digital measurement. For example, analog to digital converter 212 may discretize or sample a pressure output signal from pressure transducer 211. In other embodiments, pressure transducer 211 and/or other pressure sensors may output a digital signal. In such embodiments, TPMS sensor 210 does not include an analog to digital converter 212.

The pressure measurements from pressure transducer 211 and/or analog to digital converter 212 can be received by microcontroller 213 of TPMS sensor 210. Microcontroller 213 can determine the pressure within the tire based on the information received. For example, microcontroller 213 can apply a calibration curve to voltage received from pressure transducer 211 in order to convert output voltage into a pressure value (e.g., in pounds per square inch, pascals, BARs, or other unit of pressure). Microcontroller 213 can also communicate the measured pressure (e.g., in output voltage from pressure transducer 211 or a pressure unit such as pounds per square inch) to other hardware using ultra-high frequency transmitter 215. Microcontroller 213 can format a signal (e.g., encode or modulate a signal with pressure information, an identifier for the particular TPMS sensor 210, and/or other information) for transmission by ultra-high frequency transmitter 215.

In some embodiments, TPMS sensor 210 also includes a low frequency receiver 216 coupled to microcontroller 213. Microcontroller 213 can place itself and/or other components of TPMS sensor 210 into a low power mode (e.g., pressure transducer 211 and/or microcontroller 213 do not determine the pressure of the tire and/or do not transmit pressure information via ultra-high frequency transmitter 215 while in low power mode). TPMS sensor 210 can receive signals using low frequency receiver 216 which when executed or otherwise processed by microcontroller 213 place TPMS sensor into low power mode or cause TPMS sensor 210 to exit low power mode (e.g., begin measuring tire pressure and transmitting tire pressure information).

Microcontroller 213 can include memory 214, circuitry, a processor, and/or other circuitry, hardware, and software for performing the above described functions (e.g., calculating pressure, controlling the mode of TPMS sensor 210, and/or other functions). Microcontroller 213 can be or include a general-purpose processor, an application specific integrated circuit (ASIC), one or more field programmable gate arrays (FPGAs), a digital-signal-processor (DSP), a group of processing components, or other suitable electronic processing components. Memory 214 is one or more devices (e.g. RAM, ROM, Flash Memory, hard disk storage, etc.) for storing data and/or computer code for facilitating the various processes described herein. Memory 214 may be or include non-transient volatile memory or non-volatile memory. Memory 214 may include database components, object code components, script components, or any other type of information structure for supporting various activities and information structures described herein. Memory 214 may be communicably connected to microcontroller 213 and provide computer code or instructions to microcontroller 213 for executing the processes described herein.

Ultrahigh frequency transmitter 215 is used to transmit pressure information to TPMS electronic control unit 230. Ultra high frequency transmitter 215 can include hardware and/or software for modulating and transmitting a wireless signal in the ultra high frequency spectrum. Ultra high frequency transmitter 215 can include one or more antennas. In alternative embodiments, other spectrums may be used to transmit pressure information to TPMS electronic control unit 230. In still further embodiments, ultra high frequency transmitter 215 allows for bi-directional communication between TPMS sensor 210 and TPMS electronic control unit 230. Ultra high frequency transmitter 215 may function as a transceiver.

Low frequency receiver 216 is used to receive signals (e.g., control signals) from TPMS electronic control unit 213. Low frequency receiver 216 can include hardware and/or software for receiving and/or demodulating a wireless signal in the low frequency spectrum. Low frequency receiver 216 can include one or more antennas. Low frequency receiver 216 can receive control signals from TPMS electronic control unit 230 which change the mode of operation of TPMS sensor 210. For example, control signals may place TPMS sensor into a power saving mode in which pressure readings are not measured and transmitted, wake up TPMS sensor 210 such that TPMS sensor 210 begins measuring pressure and transmitting pressure information to TPMS electronic control unit 230, and/or otherwise control TPMS sensor 210.

In alternative embodiments, the functions of low frequency receiver 216 are performed by ultra high frequency transmitter 215. For example, ultra high frequency transmitter 215 may function as a transceiver and allow for bi-directional communication between TPMS sensor 210 and TPMS electronic control unit 230. In further embodiments, low frequency receiver 216 uses other spectrums for receiving signals from TPMS electronic control unit 230.

TPMS sensor 210 can include further components in some embodiments. For example, TPMS sensors 210 can include a power supply such as a battery. The battery may provide electrical power to the components of TPMS sensor 210. Advantageously, microcontroller 213 can place TPMS sensor 210 into a power saving mode to conserve the power source and increase the life of TPMS sensor 210. In some embodiments, the power saving mode can be controlled by control signals received using low frequency receiver 216 from TPMS electronic control unit 230. In further embodiments, the power saving mode can be controlled by a roll sensor, a time limit after which microcontroller 213 places TPMS sensor 210 into power saving mode (e.g., in response to the measured pressure reaching steady state for a determined length of time), and/or using other techniques. Advantageously, in a tire pressure monitoring system (e.g., an existing system) in which TPMS sensors 210 go into a low power mode, TPMS electronic control unit 230 can wake up or otherwise activate TPMS sensors 210 such that pressure data is gathered for use in the hands free trunk system described herein. This allows an existing system to be modified such that tire pressure data is gathered when it otherwise would not be gathered (e.g., while vehicle 100 is not moving, turned off, in park, etc.).

Referring now to FIG. 2C, a TPMS electronic control unit 230 is illustrated according to an exemplary embodiment. TPMS electronic control unit 230 can function as a controller for the TPMS. TPMS electronic control unit 230 receives pressure information from TPMS sensor 210 (e.g., using ultra high frequency receiver 231 and/or antenna 232). TPMS electronic control unit 230 also controls TPMS sensor 210 (e.g., using control signals transmitted by low frequency transmitter 237).

In one embodiment, TPMS electronic control unit 230 determines (e.g., using control circuit 233) if a tire has been kicked by a user based on the pressure information received from TPMS sensor 210. TPMS electronic control unit 230 can also determine if one or more prior conditions have been satisfied. For example, TPMS electronic control unit 230 can determine if a key fob of a remote keyless entry system is within communication range of a transceiver of the remote keyless entry system, if the vehicle 100 is started, if the vehicle 100 is in park, and/or determine other information regarding vehicle 100. Upon determining that a user has kicked a tire of vehicle 100 and that one or more prior conditions are satisfied, TPMS electronic control unit 230 can send a control signal to a body control module (e.g., using vehicle CAN interface 236 and a vehicle communications network). Depending on the configuration and/or settings of the hands free trunk system, TPMS electronic control unit 230 determines if one or varying prior conditions have been satisfied. The control signal can cause the body control module 310 to actuate one or more actuators to open a trunk 101, upper liftgate 103, lower liftgate 105, door 107, and/or window 109. TPMS electronic control unit 230 determines that a user has kicked a tire of vehicle 100 and causes trunk 101 of vehicle 100 to open in response to the kick.

In alternative embodiments, TPMS electronic control unit 230 performs a subset of these functions. For example, TPMS electronic control unit 230 can determine if a tire has been kicked and forward that determination to other electronic components of vehicle 100. TPMS electronic control unit 230 does not determine if prior conditions have been met. Alternatively, TPMS electronic control unit 230 does not determine either if a tire has been kicked or if prior conditions have been met, but instead forwards tire pressure information to other electronic components of vehicle 100 for use in the hands free operation of trunk 101 described herein.

In some embodiments, TPMS electronic control unit 230 includes control circuit 233, memory 234, and/or processor 235. The control circuit 233 may contain circuitry, hardware, and/or software for facilitating and/or performing the functions described herein. The control circuit 233 may handle inputs, process inputs, run programs, handle instructions, route information, control memory 234, control a processor 235, process data, generate outputs, communicate with other devices or hardware, and/or otherwise perform general or specific computing tasks. In some embodiments, the control circuit 233 includes a processor 235 and/or memory 234.

Processor 235 may be implemented as a general-purpose processor, an application specific integrated circuit (ASIC), one or more field programmable gate arrays (FPGAs), a digital-signal-processor (DSP), a group of processing components, or other suitable electronic processing components. Memory 234 is one or more devices (e.g. RAM, ROM, Flash Memory, hard disk storage, etc.) for storing data and/or computer code for facilitating the various processes described herein. Memory 234 may be or include non-transient volatile memory or non-volatile memory. Memory 234 may include database components, object code components, script components, or any other type of information structure for supporting various activities and information structures described herein. Memory 234 may be communicably connected to processor 235 and provide computer code or instructions to processor 235 for executing the processes described herein (e.g., determining if a user has kicked a tire based on pressure data, determining if prior conditions have been met, sending control signals to TPMS sensor 210, sending or requesting information using vehicle CAN interface 236, and/or otherwise performing the functions of TPMS electronic control unit 230 described herein).

Memory 234 and/or the control circuit 233 may facilitate the functions described herein using one or more programming techniques, data manipulation techniques, and/or processing techniques such as using algorithms, routines, lookup tables, arrays, searching, databases, comparisons, instructions, etc. For example, control circuit 233 can determine that a tire has been kicked based on pressure data by comparing the received pressure data from TPMS sensor 210 to a threshold value indicating that the tire has been kicked if the received pressure data exceeds the threshold value.

TPMS electronic control unit 230 includes ultra high frequency receiver 231. Ultra high frequency receiver 231 receives pressure data and/or information from TPMS sensor 210. Ultra high frequency receiver 231 can include hardware and/or software for receiving ultra high frequency wireless signals. For example, ultra high frequency receiver 231 can include antenna 232, a receiver, a demodulator, and/or other components. Antenna 232 may be a single antenna which is shared by TPMS electronic control unit 230 and other vehicle electronics such as a remote keyless entry system. Ultra high frequency receiver 231 provides received pressure data or information from one or more TPMS sensors 210 to control circuit 233. Control circuit 233 can use this information to determine if a tire of vehicle 100 has been kicked by a user. Control circuit 233 can also send this information to other electronic components of vehicle 100.

In alternative embodiments, ultra high frequency receiver 231 can be configured for bi-directional communication with TPMS sensor 210. For example, ultra high frequency receiver 231 can be or function as a transceiver and both send and receive wireless transmissions in the ultra high frequency spectrum. In further embodiments, ultra high frequency receiver 231 uses other spectrums for communications.

In some embodiments, TPMS electronic control unit 230 includes low frequency transmitter 237. Low frequency transmitter 237 can send transmissions or control signals from TPMS electronic control unit 230 to one or more TPMS sensors 210. Low frequency transmitter 237 can include hardware and/or software for sending control signals in a low frequency spectrum. For example, low frequency transmitter 237 can include an antenna, modulator, and/or other components. Control circuit 233 can send control signals to one or more TPMS sensors 210 using low frequency transmitter 237. For example, control circuit 233 can determine that a prior condition or initialization event (e.g., that a key fob is within communications range of a remote keyless entry system) has occurred. In response, control circuit 233 can send a control signal to one or more TPMS sensors 210 to wake up the TPMS sensors 210 from a low power mode. The control signal can cause TPMS sensors 210 to begin taking pressure readings and sending pressure information to TPMS electronic control unit 230 using ultra high frequency transmitter 215. The pressure information can be received by TPMS electronic control unit 230 using ultra high frequency receiver 231 and/or antenna 232.

In alternative embodiments, low frequency transmitter 237 can be configured for bi-directional communication with TPMS sensor 210. For example, low frequency transmitter 237 can be or function as a transceiver and both send and receive wireless transmissions in the low frequency spectrum. In further embodiments, low frequency transmitter 237 uses other spectrums for communications.

TPMS electronic control unit 230 includes power source 238. Power source 238 provides electrical power to the components of TPMS electronic control unit 230. In some embodiments, power source 238 is a power source of vehicle 100. For example, TPMS electronic control unit 230 can draw power from a vehicle power system. The vehicle power system can include a battery. In further embodiments, power source 238 can include a battery specifically for TPMS electronic control unit 230. Advantageously, TPMS electronic control unit 230 can draw power when vehicle 100 is not running or otherwise turned on. This allows the hands free operation of trunk 101 and/or other components of vehicle 100 while vehicle 100 remains off or otherwise is not running.

TPMS electronic control unit 230 includes vehicle controller area network (CAN) interface 236. Vehicle CAN interface 236 allows TPMS electronic control unit 230 to communicate with other vehicle electronics using a network. The network may be a controller area network using a CAN communication protocol. In other embodiments, other networks and/or communications protocols may be used.

Vehicle CAN interface 236 can be a transceiver which allows for sending and receiving of information via a vehicle bus (e.g., CAN). Vehicle CAN interface 236 is controlled by or otherwise coupled to control circuit 233. This allows control circuit 233 to send and receive information from other vehicle electronics systems using vehicle CAN interface 236. In some embodiments, control circuit 233 sends a request for information to other vehicle electronics and receives information in response using the vehicle network. In alternative embodiments, other vehicle electronics and/or TPMS electronic control unit 230 can provide information to other vehicle electronics on the vehicle network. Control circuit 233 can retrieve this information using vehicle CAN interface 236 (e.g., by identifying the desired information and passing it to control circuit 233).

In one embodiment, TPMS electronic control unit 230 receives information from other vehicle electronics using vehicle CAN interface 236. This information can be used by TPMS electronic control unit 230 to determine if one or more prior conditions have been met. For example, TPMS electronic control unit 230 can receive information from one or more of engine control module (ECM) 403 (e.g., whether vehicle 100 is on, the engine is running, and/or other engine information), antilock braking system (ABS) sensor 405 (e.g., if vehicle 100 is in motion as judged by a rotation counter), transmission control unit (TCU) 404 (e.g., whether the vehicle 100 is in park or another gear), a remote keyless entry (RKE) system ECU 406 (e.g., whether a key fob is in communications range with the RKE, whether the vehicle 100 is locked or unlocked, and/or other information related to the RKE), and/or other vehicle electronics. TPMS electronic control unit 230 can also send information and/or control signals to other vehicle electronics using vehicle CAN interface 236. For example, TPMS electronic control unit 230 can send a control signal which causes trunk 101, a portion thereof, and/or another vehicle component to open. The control signal can be received by one or more of a body control module 310, trunk electronic control unit 404, general purpose electronic control unit 407, and/or other vehicle electronics system.

In alternative embodiments, TPMS electronic control unit 230 can send other information, such as pressure information, from one or more TPMS sensors 210 to other vehicle electronics. For example, TPMS electronic control unit 230 can send pressure information to body control module 310, trunk electronic control unit 409, general purpose electronic control unit 407, and/or other vehicle electronics. In some embodiments, one or more of these vehicle electronics systems can use the pressure information to perform the hands free trunk operations described herein (e.g., determining, based on the pressure information, if a user has kicked a tire of vehicle 100).

TPMS electronic control unit 230 can also receive information and/or control signals from other vehicle electronics via vehicle CAN interface 411. For example, TPMS electronic control unit 230 can receive control signals from body control module 310, trunk ECU 409, general purpose ECU 407, and/or other vehicle electronics. In some embodiments, one or more vehicle electronics systems determines that a prior condition has been met and/or an initialization event has occurred (e.g., that vehicle 100 is in park, that the engine of vehicle 100 is not running, that a key fob is within communications range of the RKE system, and/or other conditions exist or do not exist). The vehicle electronics system(s) (e.g., body control module 310) can then send a control signal to TPMS electronic control unit 230. The control signal can cause TPMS electronic control unit to send a second control signal to TPMS sensor(s) 210 which wake TPMS sensor(s) 210 from a power saving mode. The control signal sent to TPMS electronic control unit 230 can also cause TPMS electronic control unit 230 to provide pressure information from the TPMS sensor(s) 210 to the other vehicle electronics (e.g., body control module 310). The other vehicle electronics (e.g., body control module 310) can then use the pressure information to perform the functions described herein related to the hands free operation of trunk 101 and/or other parts of vehicle 100.

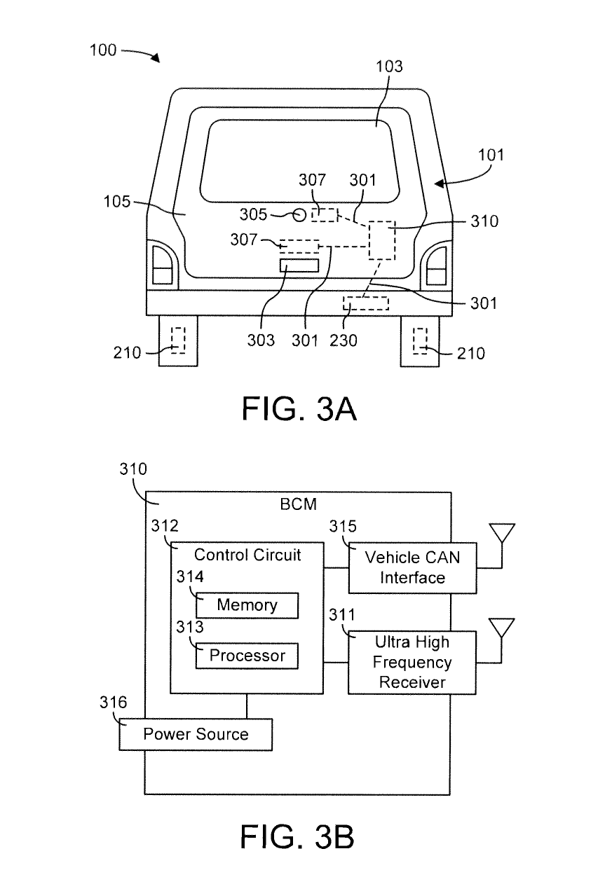

Referring now to FIG. 3A, vehicle 100 is illustrated with several components used in the hands free operation of trunk 101 according to one embodiment. Vehicle 100 can include a body control module 310. Body control module 310 controls one or more actuators 307 which are configured to open and/or close various parts of vehicle 100. Actuators 307 can be configured to operate a latch mechanism, handle 303, push button 305, or other feature of vehicle 100 for opening one or more components of trunk 101, door 107, window 109, and/or other components. For example, actuators 307 can be or include, electric motors, pneumatic cylinders, hydraulic cylinders, and/or other mechanical systems which open and/or close trunk 101. In some embodiments, trunk 101 is configured with a hydraulic, pneumatic, or other system which automatically opens trunk 101 when trunk 101 is unlatched or handle 303 or push button 305 is operated. The handle 303 and/or push button 305 can be individually controlled by a plurality of actuators 307 which are in turn controlled by body control module 310. Body control module 310 can provide electrical power to an electric motor based actuator 307, control a valve (e.g., an electrically controlled solenoid valve) which provides pneumatic pressure or hydraulic pressure to actuator 307, and/or otherwise control the operation of actuators 307. In alternative embodiments, trunk 101 (e.g., as a single component or upper liftgate 103 and lower liftgate 105 individually) can be opened or closed using one or more electric motors, pneumatic motors, and/or hydraulic motors included in actuators 307. Actuators 307 can control the entire movement of trunk 101 from an open position to a closed position and from a closed position to an open position. Body control module can control actuators 307 to open and close trunk 101.

Body control module 310 can control actuators 307 to operate trunk 101, upper liftgate 103, lower liftgate 105, doors 107, windows 109, and/or other components of vehicle 100. Actuators 307 are electrical and/or mechanical systems which control these components. Body control module 310 can control actuators 307 and therefore components of vehicle 100 in response to control signals received from other vehicle electronics. For example, body control module 310 can receive a control signal from a switch, button, vehicle infotainment system, or other vehicle system which corresponds to opening trunk 101 or a portion thereof. Body control module 310 can control actuators 307 in response to the control signal. The control signal can specify which actuator 307 to operate, specify the action to be performed (e.g., open trunk 101) with body control module 310 controlling a corresponding actuator 307, and/or can contain other information.

In some embodiments, body control module 310 receives one or more control signals from TPMS electronic control unit 230. TPMS electronic control unit can use control signals to control the operation of one or more actuators 307 via body control module 310. For example, TPMS electronic control unit 230 can determine that a tire of vehicle 100 has been kicked by a user based on pressure data from one or more TPMS sensors 210. TPMS electronic control unit can also determine if one or more prior conditions have been satisfied. In response to determining that a tire of vehicle 100 has been kicked and/or one or more prior conditions have been satisfied, TPMS electronic control unit 230 can format and send a control signal to body control module 310. In response to the control signal, body control module 310 can actuate or otherwise control one or more actuators 307 based on information in the control signal to open trunk 101 and/or perform other functions. The control signal can be sent using a vehicle bus 301 which allows for communication between TPMS electronic control unit 230, body control module 310, and/or other electronic components of vehicle 100 (e.g., actuators 307). For example, vehicle bus 301 can be a vehicle CAN or other network.

In some embodiments, body control module 310 controls actuators 307 via vehicle bus 301. Actuators 307 can be configured to receive control signals, receive information, send information, and/or otherwise communicate using vehicle bus 301. Body control module 310 can send a control signal to actuators 310 via vehicle bus 301.

In alternative embodiments, body control module 310 can control actuators 307 through a wireless or wired connection separate from vehicle bus 301. For example, body control module 310 may be wired to actuators 307 with actuators 307 not connected to vehicle bus 301.

In further embodiments, a plurality of body control modules 310 are used to perform the functions described herein with respect to a single body control module 310. For example, one body control module 310 can be used to control an actuator 307 corresponding to upper liftgate 103. A second body control module 310 can be used to control a second actuator 307 for controlling lower liftgate 105.

Referring now to FIG. 3B, body control module 310 and the components thereof are illustrated according to one embodiment. As previously described, body control module 310 controls actuators 307. Body control module 310 can control other components of vehicle 100 as well. For example, body control module 310 can control power windows, power locks, air conditioning, central locking, and/or other vehicle components. Advantageously, vehicle 100 may include or be planned to include a body control module for controlling existing components of vehicle 100. Therefore, no additional components are added to vehicle 100 for performing the functions of the hands free trunk operation system described herein. For example, an existing body control module 310 or planned body control module 310 can be programmed to perform the functions described herein related to the hands free operation of trunk 101. Body control module 310 can control actuators 307 in response to and/or based on control signals from other vehicle electronics (e.g., TPMS electronic control unit 230) and/or information from other vehicle electronics.

In some embodiments, body control module 310 includes vehicle CAN interface 315. Vehicle CAN interface 315 allows body control module 310 to communicate with other vehicle electronics. For example, body control module 310 can receive control signals and/or pressure information from TPMS electronic control unit 230 using vehicle CAN interface 315 and a vehicle network (e.g., vehicle bus 301, a CAN, or other network). Vehicle CAN interface 315 may include components for communication and/or communicate with other vehicle electronics as previously described with respect to vehicle CAN interface 236 and FIG. 2C. In some embodiments, vehicle CAN interface 315 also allows body control module 310 to control actuators 307. Body control module 310 can send control signals to actuators 310 and/or related components (e.g., a valve) which control actuators 307. The control signal can be sent to actuators 307 via vehicle bus 301 (e.g., a CAN, or other network).

In alternative embodiments, body control module 310 controls actuators 307 directly (e.g., through wired or wireless communication with actuators 307). Body control module 310 can send control signals and/or other information to actuators 307 wirelessly using ultra high frequency receiver 311 (e.g., ultra high frequency receive 311 can operate as a transceiver in some embodiments). In some embodiments, actuators 307 are wired to body control module 310. For example, actuators 307 can be wired to control circuit 312. Control circuit 312 of body control module 310 can control actuators 307 via electrical control signals and/or other information send by wired connection.

In some embodiments, body control module 310 includes ultra high frequency receiver 311. Ultra high frequency receiver 311 may function and/or include components as previously described with reference to ultra high frequency receiver 231 and FIG. 2C. Ultra high frequency receiver 311 can be used to receive wireless signals from a key fob and body control module 310 can function as a remote keyless entry system. In some embodiments, the same ultra high frequency receiver (e.g., ultra high frequency receiver 231 and ultra high frequency receiver 311 as a single receiver) is used to receive remote keyless entry system signals for a key fob and pressure data from one or more TPMS sensors 210. In some embodiments, the single ultra high frequency receiver functions as a transceiver. In further embodiments, the ultra high frequency receiver 311 of body control module 310 and the ultra high frequency receiver 231 of TPMS electronic control unit 230 share a single antenna 232.

In some embodiments, body control module 310 includes control circuit 312. Control circuit 312 can send and/or receive control signals and/or other information using vehicle CAN interface 315 and/or ultra high frequency receiver 311. Control circuit 312 can control one or more actuators 307 using control signals and/or other information sent using vehicle CAN interface 315, ultra high frequency receiver 311, a wired connection with actuator 307, and/or other communication devices. In one embodiment, control circuit 312 receives a control signal from TPMS electronic control unit 230. The control signal is received through vehicle CAN interface 315 and a vehicle network (e.g., vehicle bus 301, a CAN, or other network). Control circuit 312 can process the control signal. Processing the control signal may include determining what action to take in response to the control signal, determining the payload or specific instructions to be executed, determine how to actuate one or more actuators 307 to carry out the result specified by the control signal, and/or otherwise taking action based on the control signal. Based on the control signal received from the TPMS electronic control unit 230, body control module 310 can control one or more actuators 307 to open trunk 101 or a portion thereof.

In alternative embodiments, control circuit 312 can receive pressure information from TPMS electronic control unit 230. The pressure information can be received using vehicle CAN interface 315. Based on the pressure data, control circuit 312 can determine if a tire has been kicked by a user. In response to this determination, body control module 310 can actuate one or more actuators 307 to open trunk 101 or a portion thereof.

In further embodiments, body control module 310 can determine if one or more prior conditions has been satisfied. This can include requesting information from other vehicle electronics (e.g., ECM 403, TCU 404, RKE 406, and/or other vehicle electronics). Body control module can also send control signals to TPMS electronic control unit 230. For example, body control module 310 can send a control signal causing TPMS electronic control unit 230 to wake up TPMS sensors 210 from power save mode and to begin transmitting pressure information to body control module 310. Body control module 310 can send this control signal in response to determining that one or more prior conditions are satisfied and/or that one or more initialization events have occurred (e.g., that a key fob is communications range of an RKE system, that the vehicle 100 is in park, that the engine of the vehicle 100 is not running, etc).

The control circuit 312 may contain circuitry, hardware, and/or software for facilitating and/or performing the functions described herein. The control circuit 312 may handle inputs, process inputs, run programs, handle instructions, route information, control memory 314, control a processor 313 process data, generate outputs, communicate with other devices or hardware, and/or otherwise perform general or specific computing tasks. In some embodiments, the control circuit 312 includes a processor 313 and/or memory 314.

Processor 313 may be implemented as a general-purpose processor, an application specific integrated circuit (ASIC), one or more field programmable gate arrays (FPGAs), a digital-signal-processor (DSP), a group of processing components, or other suitable electronic processing components. Memory 314 is one or more devices (e.g. RAM, ROM, Flash Memory, hard disk storage, etc.) for storing data and/or computer code for facilitating the various processes described herein. Memory 314 may be or include non-transient volatile memory or non-volatile memory. Memory 314 may include database components, object code components, script components, or any other type of information structure for supporting various activities and information structures described herein. Memory 314 may be communicably connected to processor 313 and provide computer code or instructions to processor 313 for executing the processes described herein (e.g., controlling actuators 307, determining if a user has kicked a tire based on pressure data, determining if prior conditions have been met, sending control signals to TPMS electronic control unit 230, sending or requesting information using vehicle CAN interface 315, and/or otherwise performing the functions of body control module 310).

Memory 314 and/or the control circuit 312 may facilitate the functions described herein using one or more programming techniques, data manipulation techniques, and/or processing techniques such as using algorithms, routines, lookup tables, arrays, searching, databases, comparisons, instructions, etc.

Body control module 310 can further include power source 316. Power source 316 provides power to the components of body control module 310. In some embodiments, power source 316 is a vehicle power source such as a battery of vehicle 100 and/or other electrical power system of vehicle 100. In further embodiments, power source 316 can include a separate battery or other power source for use when vehicle 100 is off. This can allow for hands free operation of trunk 101 even if a battery of vehicle 100 is not charged. A battery of power source 316 can be charged by a vehicle power source. Power source 316 and power source 238 can have similar and/or the same features, components, and/or functions.

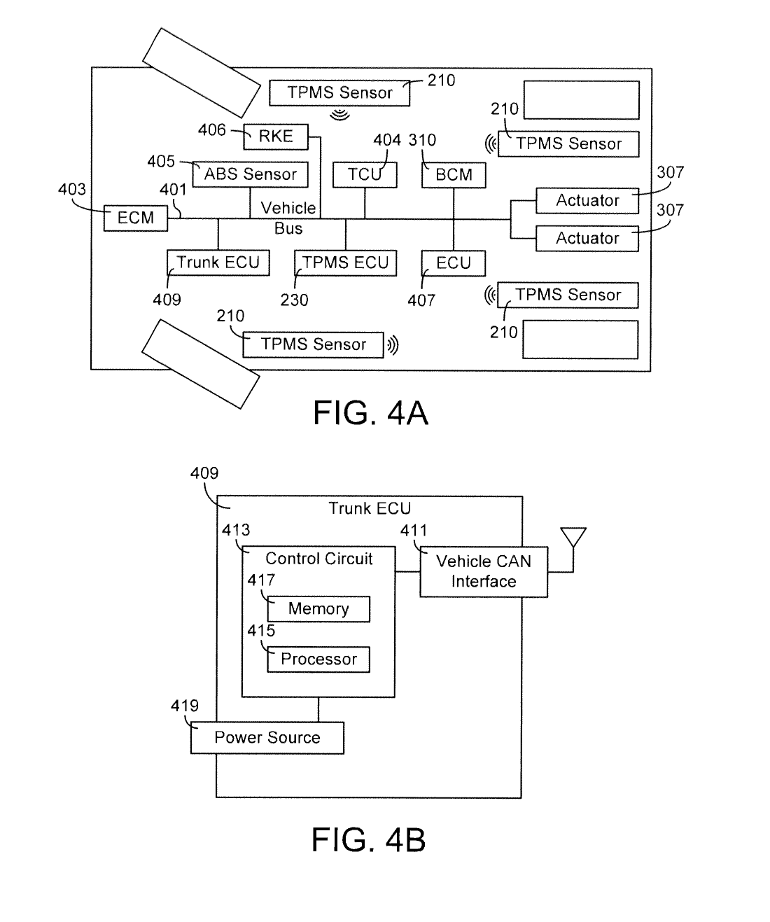

Referring now to FIG. 4A, a vehicle bus 401 (e.g., vehicle bus 301 as previously described) and components connected via vehicle bus 401 are illustrated according to one embodiment. Vehicle bus 401 can be any communications network for use by components of vehicle 100. Vehicle bus 401 and the protocols used in conjunction with vehicle bus 401 allow for communication of control signals, data (e.g., pressure data or information), and/or other information between components of vehicle 100 such as those described herein. In some embodiments, vehicle bus 401 is a wired network. In other embodiments, vehicle bus 401 is a wireless network or a network including both wired and wireless components. Protocols such as CAN protocols, local interconnect network (LIN) protocols, and/or other communication protocols (e.g., transmission control protocol and internet protocol (TCP/IP)) can be used to communicate over vehicle bus 401. In some embodiments, vehicle bus is a CAN, LIN, or Ethernet network.

Vehicle bus 401 can allow for communication between various components as previously described herein. In some embodiments, vehicle bus 401 allows for wireless communication between TPMS sensor(s) 210 and TPMS electronic control unit 230 (e.g., TPMS electronic control unit 230 can receive pressure information from TPMS sensor(s) 210). Vehicle bus 401 can allow for communication between TPMS electronic control unit 230 and ECM 403, TCU 404, ABS sensor 405, and/or RKE 406. Communication with one or more of these components can allow TPMS electronic control unit 230 to request and/or receive information for use in determining if prior conditions have been satisfied. Vehicle bus 401 can also allow for communication between TPMS electronic control unit 230 and body control module 310. For example, TPMS electronic control unit 210 can send control signals to body control module 310. In some embodiments, vehicle bus 401 allows for communication between body control module 310 and actuators 307. Body control module can control actuators 307 using control signals and/or other information send via vehicle bus 401.

In further embodiments, vehicle bus 401 allows for communication with additional electronic components of vehicle 100. Vehicle bus 401 can allow for communication with a vehicle infotainment system. The vehicle infotainment system can be implemented as a general purpose or other electronic control unit 407 or other system. The infotainment system may allow for a user to provide inputs to the hands free trunk operation system described herein. For example, a user can turn off or on the hands free trunk system, set preferences regarding the hands free trunk system, and/or otherwise customize the operation of the system. In some embodiments, a user can customize various parameters and/or aspects of the operation of the system. For example, a user can customize which prior conditions must be satisfied prior to the opening of the trunk 101. A user can specify that any set, subset, or none of prior conditions such as the following be satisfied prior to operation of the trunk 101: vehicle 100 is off, vehicle 100 is in park, a key fob of a remote keyless entry system is in communication with the remote keyless entry system, a specific key fob is in communication with the remote keyless entry system, and/or other prior conditions related to a status of vehicle 100.

Continuing the example, a user may specify the pressure threshold needed to cause trunk 101 to open. For example, a user may choose between a variety of preset pressure thresholds (e.g., hard, medium, soft). This may allow a user to customize the strength of a kick (e.g., hard, medium, soft) needed to cause trunk 101 to be opened by the hands free system. In some embodiments, a user can further customize the hands free system to take further action depending on the number of kicks detected. For example, a user may specify that one kick causes the trunk 101 to open, while two kicks causes the trunk 101 to open and vehicle 100 to be started by engine control module 403. As an alternative example, one kick can cause upper liftgate 103 to be opened, and two kicks can cause the entirety of trunk 101 (upper liftgate 103 and lower liftgate 105) to be opened. Other customization not provided herein as an example is possible.

Other features of vehicle 100 can be controlled based on the number of kicks detected, the strength of the kick detected, and/or other parameters. For example, the climate control system of vehicle 100, starting of vehicle 100, playing of music or other media by an infotainment system, and/or other aspects of vehicle 100 can be controlled using the hands free trunk system described herein.

Customized settings can be communicated to TPMS electronic control unit 230 and control circuit 233 thereof or other control circuits (e.g., included in body control module 310, ECU 407, or trunk ECU 409) and implemented by the control circuit for future use in the hands free trunk system. A control signal and/or other information pertaining to the customization by a user can be communicated by the infotainment system or other system to a control circuit of the hands free trunk system using vehicle bus 401.

In alternative embodiments, the hands free trunk system cannot be customized. A user may be prevented from customizing the system in order to maximize the safe operation of the system. In further embodiments, a user may customize some of the features or operation of the hands free trunk system but not other features and operations.

The vehicle infotainment system can also provide outputs to a user. For example, the vehicle infotainment system may include a screen and/or one or more speakers. This allows for visual and/or audio output to a user. The output of the vehicle infotainment system can aid a user in customizing the hands free trunk system described herein. The output can also provide information to the user regarding the hands free trunk system (e.g., the last time the trunk 101 was opened, and/or other statistical or usage information). The vehicle infotainment system can provide further functions using a combination of inputs and outputs. For example, the infotainment system can provide for control of a vehicle climate control system, entertainment devices (e.g., radio, movies, TV, etc.), and/or perform other general infotainment functions.

Vehicle bus 401 can further provide for communication between electronic components of vehicle 100 and a general purpose ECU 407. The general purpose ECU 407 can be any computer, ECU, or other electronic device. In some embodiments, ECU 407 provides for the functions of an infotainment system (e.g., running an operating system, handling user inputs, controlling output devices such as displays and speakers, etc.). ECU 407 can also provide any of the functions described herein with respect to TPMS electronic control unit 230 and/or body control module 310 in some embodiments.

In further embodiments, vehicle bus 401 allows for communication between electronic components of vehicle 100 and a trunk electronic control unit 409. In embodiments including trunk ECU 409, the trunk electronic control unit 409 is an ECU which performs one or more of the functions previously described herein with respect to TPMS electronic control unit 230 and/or body control module 310. Trunk ECU 409 can be a dedicated ECU added to vehicle 100 in order to control the hands free operation of trunk 101. Trunk ECU 409 can receive pressure data from TPMS sensor(s) 210 either directly or indirectly through TPMS electronic control unit 230. Trunk ECU 409 can also determine based on the pressure data if a tire of vehicle 100 has been kicked. Trunk ECU 409 can determine if one or more prior conditions have been met. Trunk ECU 409 can control TPMS sensor(s) 210 (e.g., wake up TPMS sensor(s) 210 from a power saving mode). Trunk ECU 409 can send a control signal to actuators 307 directly or indirectly through body control module 310.

Referring now to FIG. 4B, the components of trunk ECU 409 are illustrated according to one embodiment. Trunk ECU 409 can include control circuit 413. Control circuit 413 can be used to perform the functions of trunk ECU 409 described herein. Generally control circuit 413 can include components and/or operate as described with reference to control circuit 233 and/or control circuit 312.

The control circuit 413 may contain circuitry, hardware, and/or software for facilitating and/or performing the functions described herein. The control circuit 413 may handle inputs, process inputs, run programs, handle instructions, route information, control memory 417, control a processor 415 process data, generate outputs, communicate with other devices or hardware, and/or otherwise perform general or specific computing tasks. In some embodiments, the control circuit 413 includes a processor 415 and/or memory 417.

Processor 415 may be implemented as a general-purpose processor, an application specific integrated circuit (ASIC), one or more field programmable gate arrays (FPGAs), a digital-signal-processor (DSP), a group of processing components, or other suitable electronic processing components. Memory 417 is one or more devices (e.g. RAM, ROM, Flash Memory, hard disk storage, etc.) for storing data and/or computer code for facilitating the various processes described herein. Memory 417 may be or include non-transient volatile memory or non-volatile memory. Memory 417 may include database components, object code components, script components, or any other type of information structure for supporting various activities and information structures described herein. Memory 417 may be communicably connected to processor 415 and provide computer code or instructions to processor 415 for executing the processes described herein (e.g., controlling actuators 307, determining if a user has kicked a tire based on pressure data, determining if prior conditions have been met, sending control signals to TPMS electronic control unit 230, sending or requesting information using vehicle CAN interface 411, and/or otherwise performing the functions of body control module 310 and/or TPMS electronic control unit 230 described herein).

Memory 417 and/or the control circuit 413 may facilitate the functions described herein using one or more programming techniques, data manipulation techniques, and/or processing techniques such as using algorithms, routines, lookup tables, arrays, searching, databases, comparisons, instructions, etc.

Trunk ECU 409 can include vehicle CAN interface 411. Vehicle CAN interface 411 allows trunk ECU 409 to communicate with other components of vehicle 100. Vehicle CAN interface 411 can communicate using vehicle bus 401. Trunk ECU 409 can send and/or receive control signals and/or information using vehicle CAN interface 411. For example, Trunk ECU 409 can receive pressure information from TPMS electronic control unit 230 via vehicle bus 401 and vehicle CAN interface 411. Trunk ECU 409 can send control signals to actuators 307 and/or body control module 310 using vehicle CAN interface 411. In some embodiments, trunk ECU 409 includes a low frequency transmitter and/or ultra high frequency receiver. These components can be included in vehicle CAN interface 411 or otherwise included in trunk ECU 409. Using the low frequency transmitter and/or ultra high frequency receiver, trunk ECU 409 can communicate directly with TPMS sensor(s) 210 to control TPMS sensor(s) 210 and/or receive pressure information from TPMS sensor(s) 210. In further embodiments, trunk ECU 409 has a direct connection with actuators 307 which allows trunk ECU 409 to control actuators 307 without the use of vehicle bus 401.

Trunk ECU 409 can further include power source 419. Power source 419 provides power to the components of trunk ECU 409. In some embodiments, power source 419 is a vehicle power source such as a battery of vehicle 100 and/or other electrical power system of vehicle 100. In further embodiments, power source 419 can include a separate battery or other power source for use when vehicle 100 is off. This can allow for hands free operation of trunk 101 even if a battery of vehicle 100 is not charged. A battery of power source 419 can be charged by a vehicle power source. Power source 419 and power source 238 and/or power source 316 can have similar and/or the same features, components, and/or functions.

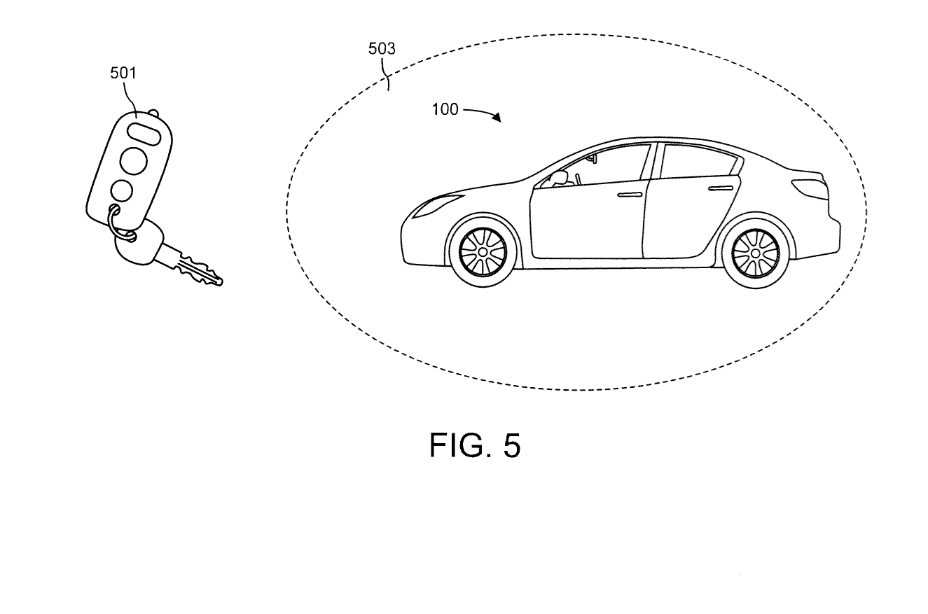

Referring now to FIG. 5, vehicle 100 is illustrated with a key fob 501 of a remote keyless entry system. As previously described herein, the hands free trunk system can use communication between key fob 501 and the remote keyless entry system (e.g., RKE system ECU 406) of vehicle 100 as a prior condition. The hands free trunk system can prevent trunk 101 from being opened in response to detected kicks from spikes in pressure data from TPMS sensor(s) 210 unless one or more prior conditions are satisfied. For example, the hands free trunk system can prevent trunk 101 from opening in response to a kick of one or more tires of vehicle 100 unless key fob 501 is communicating with the remote keyless entry system. This can prevent unauthorized entry to vehicle 100. In some embodiments, the hands free trunk system checks if key fob 501 is communicating with the remote keyless entry system prior to opening trunk 101. This ensures that the key fob (and a user carrying the key fob) are within a relatively close geographic proximity or boundary 503 with vehicle 100 prior to the trunk 101 being opened by the hands free trunk system. Boundary 503 can be defined by the communications range of key fob 501 and/or the remote keyless entry system. The hands free trunk system can be configured to not open the trunk 101 unless key fob 501 is within boundary 503.

In alternative embodiments, the remote keyless entry system can be configured to communicate with one or more control circuits of the hands free trunk system upon entering communication with key fob 501. The remote keyless entry system can determine that communication has been established with the key fob 501 and send a message and/or control signal to a control circuit of the hands free trunk system (e.g., TPMS electronic control unit 230) indicating that communication is established. TPMS electronic control unit 230 can use this information to determine that a prior condition has been satisfied. In alternative embodiments, a control circuit of the hands free trunk system (e.g., TPMS electronic control unit 230) can request information from the remote keyless entry system for use in determining if a prior condition has been satisfied.

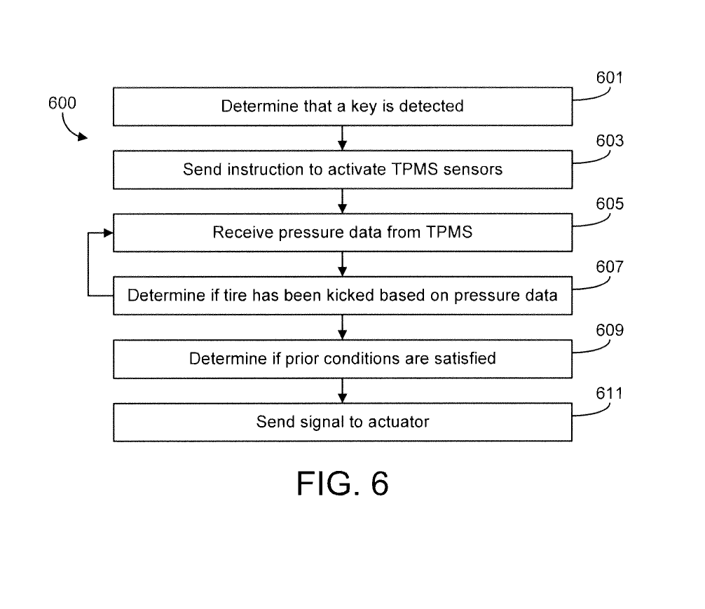

Referring now to FIG. 6, method 600 for hands free operation of a trunk 101 is illustrated according to one embodiment. It can be determined that a key fob 501 is detected or otherwise communicating with a remote keyless entry system (601). In one embodiment, TPMS electronic control unit 230 and control circuit 233 thereof determine if key fob 501 has been detected or is otherwise in communication with a remote keyless entry system. For example, control circuit 233 can send a request for information to RKE system ECU 406 using vehicle CAN interface 236. In response to the request, RKE system ECU 406 can send information (e.g., whether key fob 501 is in communication with RKE system ECU 406) to TPMS electronic control unit 230. The information can be received by control circuit 233 using vehicle CAN interface 236.

In alternative embodiments, upon establishing communication with key fob 501, RKE system ECU 406 can send information and/or a control signal to TPMS electronic control unit 230. In response TPMS electronic control unit 230 can perform additional hands free trunk operation system functions described herein. The detection of or establishment of communications with key fob 501 can be an initialization event which triggers the rest of the hands free operation process.

The hands free trunk system can send an instruction or control signal which activates TPMS sensor(s) 210 (603). In one embodiment, TPMS electronic control unit 230 send an instruction or control signal to one or more TPMS sensors 210. The instruction or control signal can be sent using low frequency transmitter 237. In response to receiving the instruction or control signal, TPMS sensor(s) 210 can exit a low power mode and being transmitting pressure data. TPMS sensor 210 can receive the instruction or control signal using low frequency receiver 216. TPMS sensor 210 processes the instruction or control signal using microcontroller 213. TPMS sensor 210 can measure the pressure within a tire using pressure transducer 211 and transmit pressure data using ultra high frequency transmitter 215.

In one embodiment, the hands free trunk operation system uses only TPMS sensors 210 for the back tires of vehicle 100. TPMS electronic control unit 230 can individually control TPMS sensors 210 using a unique identifier (e.g., serial number or other transmission identifier) corresponding to each TPMS sensor 210. Using the unique identifier, TPMS electronic control unit 230 can send control signals to one or more rear tires of vehicle 100 only. TPMS electronic control unit 230 can also identify the source of pressure information (e.g., with which tire it corresponds) based on the unique identifier transmitted with the pressure data by TPMS sensors 210. In alternative embodiments, the hands free trunk system uses all or a different subset of TPMS sensors 210 included in vehicle 100.

In alternative embodiments, TPMS sensor(s) 210 can be in an always on state. In such an embodiment, no instruction to activate TPMS sensors 210 is sent by the hands free trunk system. Instead, TPMS sensors 210 can continuously transmit pressure data to one or more of TPMS electronic control unit 230, body control module 310, trunk ECU 409, or a general purpose ECU 407.

The pressure data and/or other information transmitted by the TPMS sensor(s) 210 can be received (605). In one embodiment, the pressure data and/or other information is received by TPMS electronic control unit 230. TPMS electronic control unit 230 can receive the pressure data and/or other information from TPMS sensor(s) 210 using high frequency receiver 231. The pressure data and/or other information can be passed from ultra high frequency receiver 231 to control circuit 233.

The hands free trunk system can determine if a tire has been kicked based on the pressure data and/or other information (607). In one embodiment, TPMS electronic control unit 230 determines if a tire has been kicked based on the pressure data and/or other information. Control circuit 233 can be used including processor 235, memory 234, and/or software or programs. A variety of techniques can be used to analyze or otherwise process the pressure data and/or other information to determine if a tire has been kicked. For example, control circuit 233 can compare the pressure data to a threshold pressure value. If the measured tire pressure as reflected by the pressure data exceeds the threshold pressure value, TPMS electronic control unit 230 can determine that a tire has been kicked. As another example, control circuit 233 can compare a series of pressure data points reflecting the measured pressure to a curve, profile, or other set of reference data points which reflect a kick. If the measured data and reference data are in sufficient agreement, TPMS electronic control unit 230 can determine that a tire has been kicked. Further data analysis techniques may be used in alternative embodiments. For example, techniques such as bounded comparisons, curve fitting, statistical analysis, and/or other techniques may be used to analyze pressure data and/or other information to determine if a tire of vehicle 100 has been kicked.

In further embodiments, TPMS electronic control unit 230 can determine the type of input received. For example, TPMS electronic control unit 230 can determine that a tire has been kicked as described above and can further determine the number of times the tire has been kicked. TPMS electronic control unit 230 can analyze pressure data from TPMS sensors 210 for a predetermined amount of time in order to determine the number of kicks. Other techniques can be used. As a further example, TPMS electronic control unit 230 can determine the strength of a kick. TPMS electronic control unit 230 can compare pressure data, which is determined to corresponds to a kick, to a series of threshold values (e.g., a low pressure threshold, a medium pressure threshold, and a high pressure threshold). Depending on which thresholds are exceeded, TPMS electronic control unit 230 can determine the strength of the kick. Other techniques (e.g., curve fitting, model comparison, etc.) can be used. In still further embodiments, other parameters, qualities, and/or characteristics related to a kick can be determined.

The hands free trunk system can continue to receive pressure data from the tire pressure monitoring system and can continue to determine if a tire has been kicked based on the pressure data. This cycle of iterations can continue until an end condition has been satisfied. For example, an end condition may be determining that a tire has been kicked, determining that a tire has been kicked a maximum number of times (e.g., three times), determining that an engine of vehicle 100 has been started, determining that vehicle 100 is no longer in park, determining that a key fob 501 is no longer in communication with a remote keyless entry system, determining that a predetermine period of time has elapsed, determining that a predetermined amount of time following a determination that a tire has been kicked has elapsed, determining that a window 109 and/or door 107 of vehicle 100 has been opened, and/or that vehicle 100 has changed state in regards to other parameters. Information for making one or more of these determinations can be received from other vehicle components (e.g., ECM 403, TCU 404, RKE 406, etc.) using vehicle bus 401.

If it is determined that a tire has been kicked, the hands free trunk system determines if one or more prior conditions are satisfied (609). In one embodiment, TPMS electronic control unit 230 determines if one or more prior conditions are satisfied. The prior conditions can be one or more conditions, values, or parameters which must be satisfied, true, or a specific value before the hands free trunk system will cause trunk 101 to open. Prior conditions can include that the vehicle 100 is in park (e.g., determined using information from TCU 404), that the engine of vehicle 100 is not running (e.g., determined using information from ECM 403), that key fob 501 is in communication with a remote keyless entry system (e.g., determined using information from RKE system ECU 406), and/or other vehicle status or conditions. Information used in determining that one or more prior conditions is satisfied can be received by or requested by TPMS electronic control system 230 using vehicle bus 401. Control circuit 233 can make the determination using techniques including one or more of Boolean operators, flags, comparison tests, if then arguments, and/or other techniques. The number and/or type of prior conditions which must be satisfied can be customizable by a user in some embodiments.

If it is determined that the one or more prior conditions have been satisfied, the hands free trunk system can send a signal and/or other information which causes actuator 307 to open trunk 101. In one embodiment, TPMS electronic control unit 230 sends a control signal and/or other information which causes actuators 307 to open trunk 101 or another action to occur. For example, TPMS electronic control unit 230 can send a control signal to body control module 310 which causes body control module 310 to control actuators 307 and open trunk 101. TPMS electronic control unit 230 can send the control signal and/or other information using vehicle Can interface 236 and vehicle bus 401. Body control module 310 can receive the control signal and/or other information using vehicle can interface 315. Body control module 310 can process the control signal and/or other information using control circuit 312 and control one or more actuators 307 in response to the control signal and/or other information. Actuators 307 can cause trunk 101 to open.

In some embodiments, the control signal and/or other information sent by TPMS electronic control unit 230 varies depending on user customizable settings and/or the type of user input received. For example, a user may customize how trunk 101 is opened in response to a kick of a tire of vehicle 100 (e.g., upper liftgate 103 may be opened or the entirety of trunk 101 may be opened depending on the user controlled settings). Continuing the example, a single kick of a tire of vehicle 100 may cause a first action (e.g., upper liftgate 103 is opened). If the hands free trunk system determines that a tire has been kicked two times (e.g., within a predetermined time window), the hands free trunk system can open the entirety of trunk 101 (e.g., lower liftgate 105 and upper liftgate 103). In further embodiments, the strength of the kick detected can cause a particular action as well (e.g., a soft kick opens upper liftgate 103, while a hard kick opens the entirety of trunk 101). Other actions may also be taken such as control of a vehicle climate control system, vehicle powertrain, and/or control of other vehicle systems.

To facilitate control based on customizable settings and/or input type, control circuit 233 of TPMS electronic control unit 230 can format control signals and/or other information based on the customized settings and/or detected input type. The control signals and/or other information may be configured to cause the specific action associated with the customized settings and/or input.

Still referring to FIG. 6, in alternative embodiments, other hardware combinations can be used to receive pressure data from TPMS sensors 210. For example, pressure data and/or other information can be received from TPMS sensors 210 directly by trunk ECU 409, general purpose ECU 407, and/or body control module 310. In further embodiments, pressure data from TPMS sensors 210 can be received indirectly by body control module 310, trunk ECU 409, and/or general purpose ECU 407. For example, TPMS electronic control unit 230 can forward pressure data and/or other information to these or other electronic components using vehicle bus 401.

In some alternative embodiments, hardware other than TPMS electronic control unit 230 is used to determine if a tire has been kicked based on the pressure data. In one alternative embodiment, the body control module 310 receives pressure data and/or other information and determines (e.g., using control circuit 312) that a tire has been kicked based on the pressure data and/or other information. Techniques the same or similar to those discussed with respect to TPMS electronic control unit 230 can be used. In other alternative embodiments, trunk ECU 409 can make the determination (e.g., using control circuit 413) of whether a tire has been kicked based on the pressure data (e.g., received from TPMS electronic control unit 230). In further alternative embodiments, a general purpose ECU 407 can make the determination (e.g., using a control circuit) of whether a tire has been kicked based on the pressure data (e.g., received from TPMS electronic control unit 230).

In some alternative embodiments, hardware other than TPMS electronic control unit 230 is used to determine if prior conditions are satisfied. For example, body control module 310 (e.g., including control circuit 312), trunk ECU 409 (e.g., including control circuit 413), or general purpose ECU 407 can determine if prior conditions have been satisfied. The same or similar techniques described with reference to TPMS electronic control unit 230 can be used.

In some alternative embodiments, hardware other than TPMS electronic control 230 sends a signal which controls actuators 307 directly or indirectly (e.g., through body control module 310). For example, body control module 310 can receive pressure data and/or other information, determine that a tire has been kicked, determine if prior conditions are satisfied, and control actuators 307. As another example, trunk ECU 409 can receive pressure data (e.g., from TPMS electronic control unit 230), determine that a tire has been kicked, determine if prior conditions are satisfied, and send a control signal to body control module 310 causing actuators 307 to be controlled such that trunk 101 is opened.

In still further embodiments, other events, hardware, and/or software may be used to initialize the trunk opening process and/or the hands free trunk system. The trunk opening process may be initialized in response to the occurrence of an initialization event. For example, rather than determining that a key fob 501 is in communication range with a remote keyless entry system, the hands free trunk system can determine that another event has occurred. In response to the event, the hands free trunk system can activate TPMS sensors 210, receive pressure data, determine if a tire has been kicked, determine if prior conditions are satisfied, send a control signal to an actuator 307, and/or perform other functions. Other events (e.g., initialization events) may include detecting the presence of a user using one or more cameras of vehicle 100. For example, vehicle 100 may include a backup camera, side looking cameras (e.g., for blind spot detection), and/or other cameras. An ECU (e.g., general purpose ECU 407) can detect the user using information from one or more cameras. In some embodiments, the ECU can identify a particular user as authorized to operate the hands free trunk system based on a gesture made by the user. The ECU can use video processing techniques to match the gesture performed to one stored in memory. In response to identifying a user, the hands free trunk system can activate TPMS sensors 210, receive pressure data, determine if a tire has been kicked, determine if prior conditions are satisfied, send a control signal to an actuator 307, and/or perform other functions.

In additional embodiments, other events may include detecting a user using a radar based lane departure warning system. In response, the hands free trunk system can activate TPMS sensors 210, receive pressure data, determine if a tire has been kicked, determine if prior conditions are satisfied, send a control signal to an actuator 307, and/or perform other functions.

In further embodiments, other events may include detecting a user with a Bluetooth connection to a user's mobile phone. Vehicle 100 can include a Bluetooth wireless communication system. For example, the Bluetooth wireless communication system may be part of a vehicle infotainment system. A user may pair his or her mobile phone to vehicle 100 for use in making telephone calls or consuming media using the mobile phone and components of the vehicle infotainment system. The Bluetooth communication system and/or the mobile phone may be configured to connect to each other (e.g., establish a communications link) when the mobile phone and vehicle 100 are within communication range. In response to establishing the communication link, the Bluetooth communications system can notify the hands free trunk system (e.g., using vehicle bus 401). In alternative embodiments, the hands free trunk system can request this information from the Bluetooth communication system. In response to determining that a communication link has been established between vehicle 100 and a mobile phone (e.g., a previously paired mobile phone), the hands free trunk system can activate TPMS sensors 210, receive pressure data, determine if a tire has been kicked, determine if prior conditions are satisfied, send a control signal to an actuator 307, and/or perform other functions.

In still further embodiments, other events may include determining that vehicle 100 is within close geographic proximity to a location such as a user's home or other location provided by a user to the hands free trunk system. Vehicle 100 can include a global positioning system. An ECU or other components of the hands free trunk system can be in communication with the global positioning system of vehicle 100. Using location information from the global positioning system and/or information entered by a user (e.g., a home location entered through an infotainment system as part of customizing the hands free trunk system), the hands free trunk system can determine (e.g., using a control circuit or ECU) that the vehicle 100 is within close proximity to the location. In response, the hands free trunk system can activate TPMS sensors 210, receive pressure data, determine if a tire has been kicked, determine if prior conditions are satisfied, send a control signal to an actuator 307, and/or perform other functions.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A tire pressure monitoring system electronic control unit for hands free operation of a trunk of a vehicle, comprising:
a receiver configured to receive pressure data transmitted from at least one tire pressure monitoring system sensor, wherein the tire pressure monitoring system sensor is configured to monitor the pressure within a tire of the vehicle;
a vehicle controller area network interface, wherein the vehicle controller area network interface is configured to send a control signal to a body control module using a vehicle network; and
a control circuit configured to send the control signal to the body control module using the vehicle controller area network interface,
wherein the control signal causes the body control module to open the trunk of the vehicle, and
wherein the control circuit sends the control signal in response to determining, using the pressure data, that the tire of the vehicle has been kicked.

2. The tire pressure monitoring system electronic control unit of claim 1, further comprising a transmitter configured to transmit a second control signal to the tire pressure monitoring system sensor, wherein the second control signal causes the tire pressure monitoring system sensor to exit a power saving mode and transmit pressure data.

3. The tire pressure monitoring system electronic control unit of claim 2, wherein the control circuit is configured to transmit the second control signal using the transmitter in response to determining that a key fob and a remote keyless entry system of the vehicle are in communication, wherein the control circuit determines that the key fob and the remote keyless entry system of the vehicle are in communication based on information received from the remote keyless entry system using the vehicle controller area network interface.

4. The tire pressure monitoring system electronic control unit of claim 1, wherein the control circuit is further configured to determine, based on information received using the vehicle controller area network interface, that at least one prior condition is satisfied, and wherein the control circuit sends the control signal only after determining that at least one prior condition is satisfied.

5. The tire pressure monitoring system electronic control unit of claim 4, wherein the prior condition is at least one of a key fob being in communication with a remote keyless entry system of the vehicle, the vehicle being in park, or an engine of the vehicle being off.

6. The tire pressure monitoring system electronic control unit of claim 5, wherein the information received using the vehicle controller area network interface is at least one of communication status information from a remote keyless entry system electronic control unit, transmission information from a transmission control unit, or engine state information from an engine control module.

7. The tire pressure monitoring system electronic control unit of claim 1, wherein the control circuit is further configured to determine, based on the pressure data, at least one of the number of times the tire has been kicked and a strength of a kick.

8. The tire pressure monitoring system electronic control unit of claim 7, wherein the number of times the tire is kicked is determined based on the number of times the control circuit determines the tire is kicked within a predetermined time period, and wherein the strength of the kick is determined using a series of increasing pressure threshold values.

9. The tire pressure monitoring system electronic control unit of claim 7, wherein the control circuit sends different control signals based on the number of times the tire has been kicked or the strength of the kick, and wherein the different control signals cause the vehicle to take different actions.

10. The tire pressure monitoring system electronic control unit of claim 1, wherein the hands free operation of the trunk is user customizable.

11. A method for operating a trunk of a vehicle based on a kick of a tire of the vehicle, comprising:
receiving pressure data at a control circuit from, directly or indirectly, one or more tire pressure monitoring system sensors;
determining, using the control circuit, if the tire of the vehicle has been kicked based on the pressure data; and
sending a control signal, directly or indirectly, to an actuator,
wherein the actuator opens the trunk of the vehicle in response to receiving the control signal.

12. The method of claim 11, further comprising determining, using the control circuit, if a prior condition is satisfied, where the control signal is not sent in response to determining that the prior condition is not satisfied.

13. The method of claim 12, wherein the prior condition is at least one of a key fob being in communication with a remote keyless entry system of the vehicle, the vehicle being in park, or an engine of the vehicle being off.

14. The method of claim 11, further comprising sending an instruction, directly or indirectly, to one or more tire pressure monitoring system sensors, wherein the instruction causes the tire pressure monitoring system sensor to exit a power saving mode and begin transmitting pressure data.

15. An apparatus for a vehicle and for hands free operation of a portion of the vehicle, comprising:
a tire pressure sensor configured to measure the pressure within a tire of the vehicle;
an actuator coupled to the portion of the vehicle and configured to cause the portion of the vehicle to open in response to a control signal; and
a control circuit configured to receive pressure data from the tire pressure sensor and configured to send the control signal to the actuator,
wherein the control circuit is configured to send the control signal in response to determining, based on the pressure data, that the tire has been kicked.

16. The apparatus of claim 15, wherein the control circuit is further configured to activate the tire pressure sensor in response to an initialization event.

17. The apparatus of claim 16, wherein the initialization event is at least one of establishing communications between a key fob and a remote keyless entry system, a camera system of the vehicle detecting a user, a camera system of the vehicle detecting a gesture of a user, a radar based system detecting a user, establishing communication between a Bluetooth communication system of the vehicle and a mobile phone, or the vehicle being within close geographic proximity to a specific location.

18. The apparatus of claim 15, wherein the control circuit is further configured to determine that at least one prior condition is satisfied prior to sending the control signal.

19. The apparatus of claim 15, wherein the control circuit is included in one of a tire pressure monitoring system electronic control unit, a body control module, a trunk electronic control unit, or a general purpose electronic control unit.

20. The apparatus of claim 15, wherein the control circuit is customizable by a user to control the operation of one or more of a trunk of the vehicle, a climate control system of the vehicle, an infotainment system of the vehicle, and a powertrain of the vehicle in response to determining that the tire has been kicked.
